(19) United States
(12) Patent Application Publication
(10) Pub. No.: US 2003/0137460 A1
(43) Pub. Date: Jul. 24, 2003

(54) Antenna system for a wireless input system

(75) Inventor: Chien-Chih Chiu, Dali City (TW)

Correspondence Address: Richard P. Berg, Esq., c/o LADAS & PARRY, Suite 2100, 5670 Wilshire Boulevard, Los Angeles, CA, 90036-5679, US

(73) Assignee: DARFON ELECTRONICS CORP.

(21) Appl. No.: 10/322,206

(22) Filed: Dec. 17, 2002

(30) Foreign Application Priority Data
Jan. 18, 2002 (TW) 91100823

(51) Int. Cl. H01Q 1/24

(52) U.S. Cl. 343/702

(57) ABSTRACT

An antenna system for a wireless input device. The antenna system includes an antenna for radiating signals of the wireless input device and a metallic conductor, which is near the antenna and isolated from the antenna, to enhance radiation efficiency.

### BACKGROUND OF THE INVENTION

1. Field of the Invention

The present invention relates to an antenna system, and particularly to an antenna system for a wireless keyboard which takes advantage of parasitic effect to enhance radiation efficiency.

2. Description of the Related Art

For emerging wireless transmission devices, radiation fields have a great effect on wireless transmission. Radiation fields are affected by dimension, geometry, and ambience, such as metallic plates or housings of wireless transmission devices. Dimensions of an antenna must be large enough compared to wavelengths of radio waves that the antenna can transmit signals efficiently. Geometry of an antenna determines polarization and radiation pattern. Ambience can enhance or lessen radiation fields. For antennas in the electronics market, the most economical and efficient way to enhance radiation efficiency is to improve radiation patterns of antennas. For example, a metallic plate in wireless keyboard design provides rigidity and common ground, but impedes signal transmission and lessens radiation efficiency. Without additional components and redesign, the metallic plate in a wireless keyboard must be well utilized, such as utilizing good conductor characteristics to converge electric fields in space so that radiation power is compatible with transmission requirements.

Conventional metallic plates of wireless keyboards are used as extensions of antennas to increase lengths of current paths, thus improving transmission efficiency.

FIG. 1 shows a block diagram including a conventional wireless keyboard and a computer system. The computer system 101 includes a CPU, an interface bus, and a video circuit coupled to a display 120. The computer system 101 receives signals from peripheral devices by a receive circuit. The receive circuit receives signals from a wireless keyboard 201 or from a wireless mouse 301.

When the wireless keyboard 201 operates, the wireless keyboard 201 outputs radio signals representing input keys and the computer system 101 receives the radio signals, transforms the radio signals into text codes related input keys, proceeds the text codes, and sends it to the display 120.

FIG. 2B shows an exterior structure of a conventional wireless keyboard. FIG. 2C shows an interior structure of the conventional wireless keyboard. The wireless keyboard 201 includes a keyswitch pad 234, a keyswitch printed circuit membrane 232, a RF module 202, and a metallic plate 230. When pressing a key, the keyswitch pad 234 and the key switch printed circuit membrane 232 have a common ground provided by the metallic plate 230.

FIG. 2A shows the RF module 202 and the keyswitch printed circuit membrane 232 in the conventional wireless keyboard. The keyswitch printed circuit membrane 232 transmits keys pressed signals to the RF module 202. The signals are fed to antenna by RF module 202 and sent to the computer system 101 by radio signal.

A conventional antenna in the wireless keyboard is shown in FIG. 3A. A first terminal of a monopole antenna 240 is coupled to a first terminal of the wireless transmission circuit 210. A second terminal of the wireless transmission circuit 210 is coupled to a ground 220 of the RF module 202. The monopole Antenna 240 is near and parallel to an edge of the metallic plate 230. The metallic plate 230 is coupled to the ground 220 of the RF module 202 via the connection line 221 so that the metallic plate 230 and the RF module 202 have the same ground.

Owing to good conductor characteristic of the metallic plate 230, its effect can be achieved by its replacement with an image current in phase with the actual current in the monopole antenna 240. The image current and the actual current maintain zero tangential electric field. A current C240 of the monopole 240 is parallel to the metallic plate 230, so an image current I240 flows in the opposite direction and is parallel to the monopole antenna 240. The image current I240 lessens the radiation intensity of the monopole antenna 240.

Another antenna system within a wireless keyboard is shown in FIG. 3B. One end of a wire 242 is coupled to the wireless transmission circuit 210 of the RF module 202, and the other end of the wire 242 is coupled to the metallic plate 230. The metallic plate 230 is coupled to the ground 220 of the RF module 202 via a wire 221. The RF module 202 and the metallic plate 230 have the same common ground.

The wire 242 is coupled to the metallic plate 230 to form a loop antenna. The loop antenna is coupled to the wireless transmission circuit 210 to generate a radiation magnetic source. The peripheral length of the loop antenna is approximately equivalent to the sum of the length of the metallic plate 230, the length of the wire 242, and the height of the wire 242. The space between the wire 242 and metallic plate 230 provides a large antenna loop surface for transmitting the RF signal efficiently. The RF module 202 and the metallic plate 230 have the same common ground, thus the signals of the RF module 202 have a path coupled to the metallic plate 230 to interfere with the other signals.

In order to avoid adverse effects caused by image charges and interference from metallic plates, without additional components, there is a need to make use of parasitic effects of the given metallic plate within a wireless keyboard to improve radiation efficiency and reduce power consumption.

### SUMMARY OF THE INVENTION

It is therefore an object of the present invention to provide an antenna system with better radiation efficiency.

To achieve the above objects, the present invention provides an antenna with a parasitic component.

According to the embodiment of the invention, the antenna system for a wireless input device includes an antenna and a metallic plate. The antenna radiates signals from the wireless input device. The metallic plate, near the antenna by a distance D and isolated from the antenna, enhances radiation efficiency. The distance D is less than 2 centimeters.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 shows a diagram of a conventional wireless keyboard and a computer system;

FIG. 2A shows the RF module and the keyswitch printed circuit membrane in the conventional wireless keyboard.

FIG. 2B shows an exterior structure of the conventional wireless keyboard;

FIG. 2C shows an interior structure of the conventional wireless keyboard;

FIGS. 3A-3B shows an antenna system in the conventional wireless keyboard;

FIG. 4A shows a monopole antenna system in the wireless keyboard according to the first embodiment;

FIG. 4B shows a monopole antenna system in the wireless keyboard according to the second embodiment;

FIG. 5A shows a loop antenna system in the wireless keyboard according to the third embodiment; and

FIG. 5B shows a loop antenna system in the wireless keyboard according to the fourth embodiment.

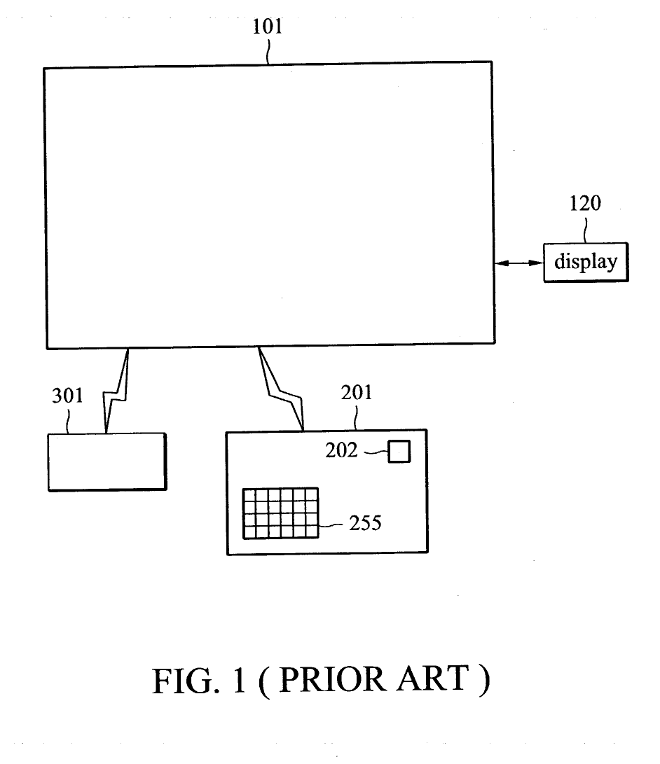

### DETAILED DESCRIPTION OF THE INVENTION

The present invention mainly takes advantages of parasitic effects to enhance radiation efficiency of antennas.

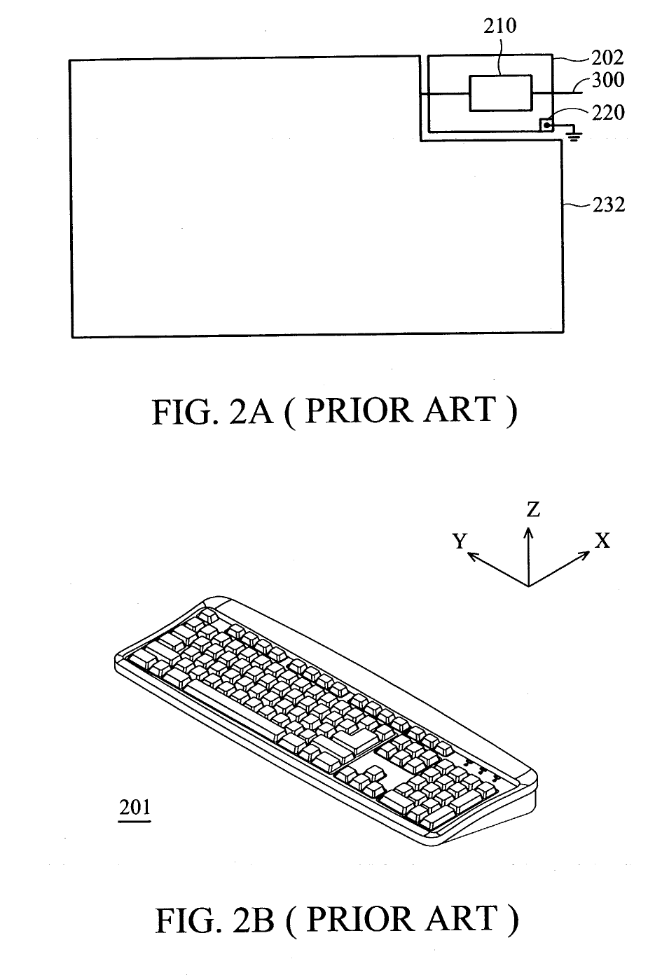

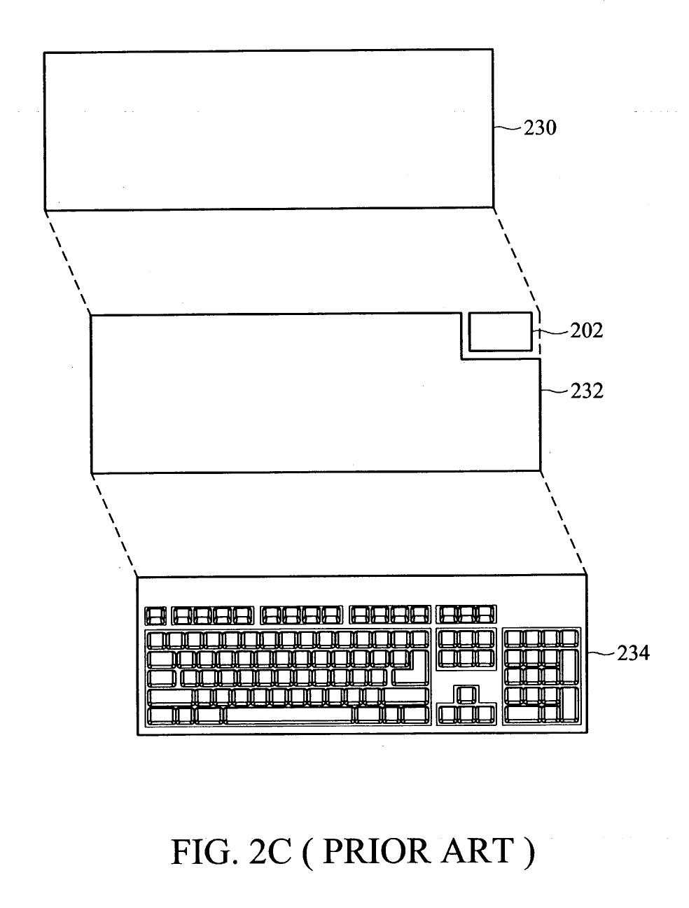

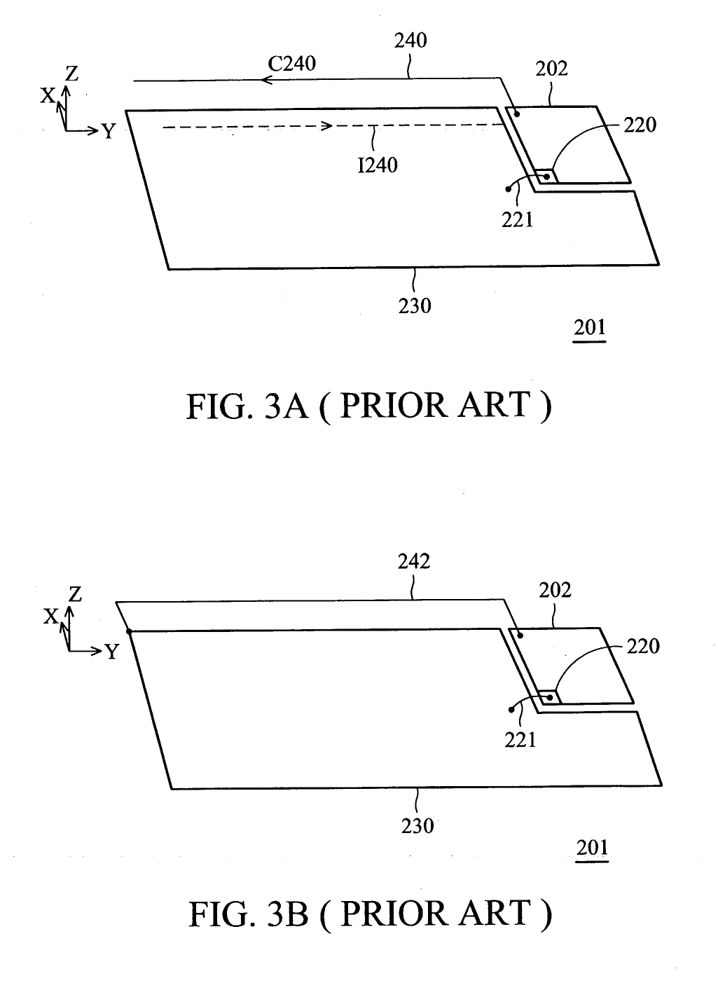

The block diagram of the RF module in the following embodiments is shown in FIG. 2A. The RF module 202 includes the wireless transmission circuit 210 as shown and the ground 220. The wireless transmission circuit 210 includes a keyswitch scan circuit, an encoder, a modulator, and an amplifier circuit. In the following embodiments, the ground of the antenna and the antenna are both isolated from the metallic plate, thus there is no induced image charge lessening radiation power and no interference caused by the common ground of the metallic plate. The metallic plate is close to the antenna in a very small distance compared to wavelength, such as one-tenth wavelength, and at various azimuths, but does not contact the metallic plate. The distance between the antenna and the metallic plate is D, and D is less than 2 centimeters. The metallic plate improves directivity gain of the antenna.

The First Embodiment

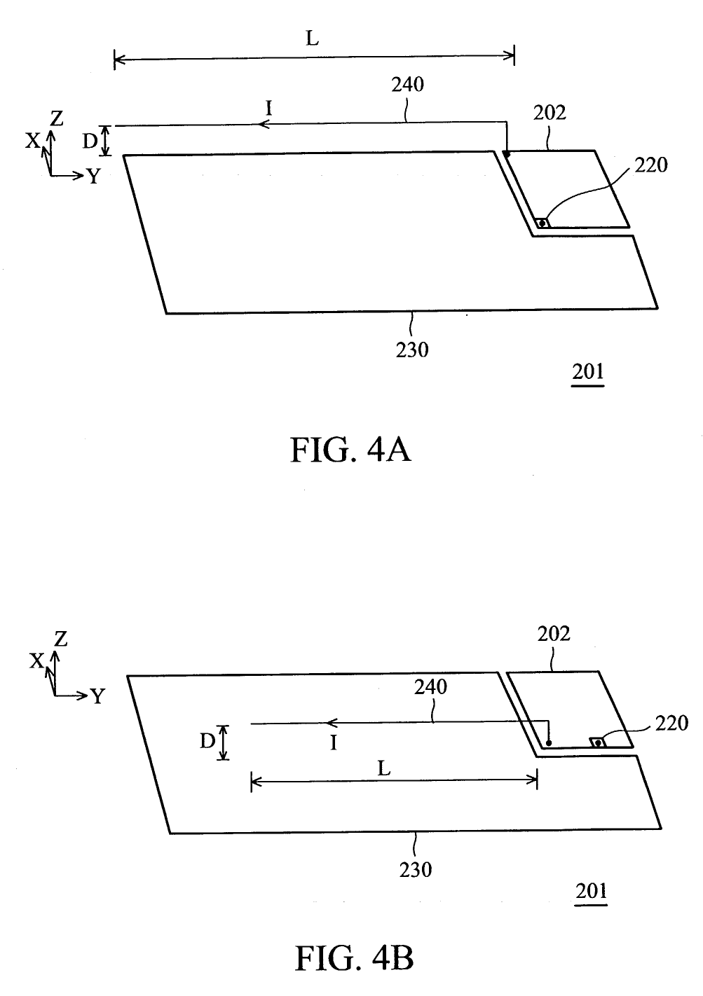

The wireless keyboard in the first embodiment is shown in FIG. 4A. The wireless keyboard includes a monopole antenna 240 and a metallic plate 230. The first end of the monopole antenna 240 is coupled to the wireless transmission circuit 210 of the RF module 202. The ground end of the wireless transmission circuit 210 is coupled to the ground 220. The monopole antenna 240 is near an edge of the metallic plate 230 and is parallel to the edge of the metallic plate 230, but does not contact any portion of the metallic plate, that is, the metallic plate 230 is isolated from the monopole antenna 240. The distance between the antenna 240 and the metallic plate 230 is D, and D is less than 2 centimeter.

The monopole antenna 240 and the metallic plate 230 are on the same plane, XY plane. The monopole antenna 240 radiates electromagnetic waves propagating in the negative X direction to the front edge of the metallic plate 230 and a scattering wave occurs. The omnidirection radiation pattern is changed and the radiation directivity in the X direction is enhanced. The radiation efficiency in the X direction is improved. The improvement in radiation efficiency is determined by the mutual impedance between the driving antenna, the monopole antenna 240, and parasitic component, the metallic plate 230 and the self impedance of the parasitic component. The mutual impedance is determined by the length of the monopole antenna 240, the length of the portion of the metallic plate 230 proximate to the monopole antenna 240, and the distance between the monopole antenna 240 and the metallic plate 230. When the beam is in the direction from the metallic plate 230 to the monopole antenna 240, the metallic plate 230 is called a reflector. When the beam is in the direction from the monopole antenna 240 to the metallic plate 230, the metallic plate 230 improves radiation efficiency.

When the length L of the monopole antenna 240 and the length of the portion of the metallic plate 230 adjacent to the monopole antenna 240 are both less than or equal to one-fourth resonance wavelength λ/4, the mutual impedance between the monopole antenna 240 and the metallic plate 230 is mainly determined by the distance D and the resonance wavelength λ.

The distance D is smaller, the parasitic effects caused by parasitic component are more significant. That is, the mutual impedance between the monopole antenna and the metallic plate is greater, the radiation gain of the monopole antenna 240 is greater.

The Second Embodiment

The wireless keyboard in the second embodiment is shown in FIG. 4B. The wireless keyboard includes monopole antenna 240 and metallic plate 230. The first end of the monopole antenna 240 is coupled to the wireless transmission circuit 210 of the RF module 202. The ground end of the wireless transmission circuit 210 is coupled to the ground 220. The monopole antenna 240 is near an edge of the metallic plate 230 and is parallel to the edge of the metallic plate 230, but does not contact any portion of the metallic plate and thereby isolated there from. The distance between the antenna 240 and the metallic plate 230 is D, and D is less than 2 centimeter.

The monopole antenna 240 and the metallic plate 230 are on the same plane, XY plane. The monopole antenna 240 radiates electromagnetic waves propagating in the negative Z direction to the surface of the metallic plate 230 and a scattering wave is occurred. The omnidirection radiation pattern is changed and the radiation directivity in the Z direction is enhanced. The radiation efficiency in the Z direction is improved. The improvement in radiation efficiency is determined by the mutual impedance between the driving antenna, the monopole antenna 240, and parasitic component, the metallic plate 230 and the self impedance of the parasitic component. The mutual impedance is determined by the length of the monopole antenna 240, the length of the portion of the metallic plate 230 adjacent to the monopole antenna 240, and the distance between the monopole antenna 240 and the metallic plate 230. When the beam is in the direction from the metallic plate 230 to the monopole antenna 240, the metallic plate 230 is called a reflector. When the beam is in the direction from the monopole antenna 240 to the metallic plate 230, the metallic plate 230 improves radiation efficiency.

When the length L of the monopole antenna 240 and the length of the portion of the metallic plate 230 adjacent to the monopole antenna 240 are both less than or equal to one-fourth resonance wavelength λ/4, the mutual impedance between the monopole antenna 240 and the metallic plate 230 is mainly determined by the distance D and the resonance wavelength λ.

The distance D is smaller, the effect caused by parasitic component is greater. That is, the mutual impedance between the monopole antenna and the metallic plate is greater, the radiation gain of the monople antenna 240 is greater.

The Third Embodiment

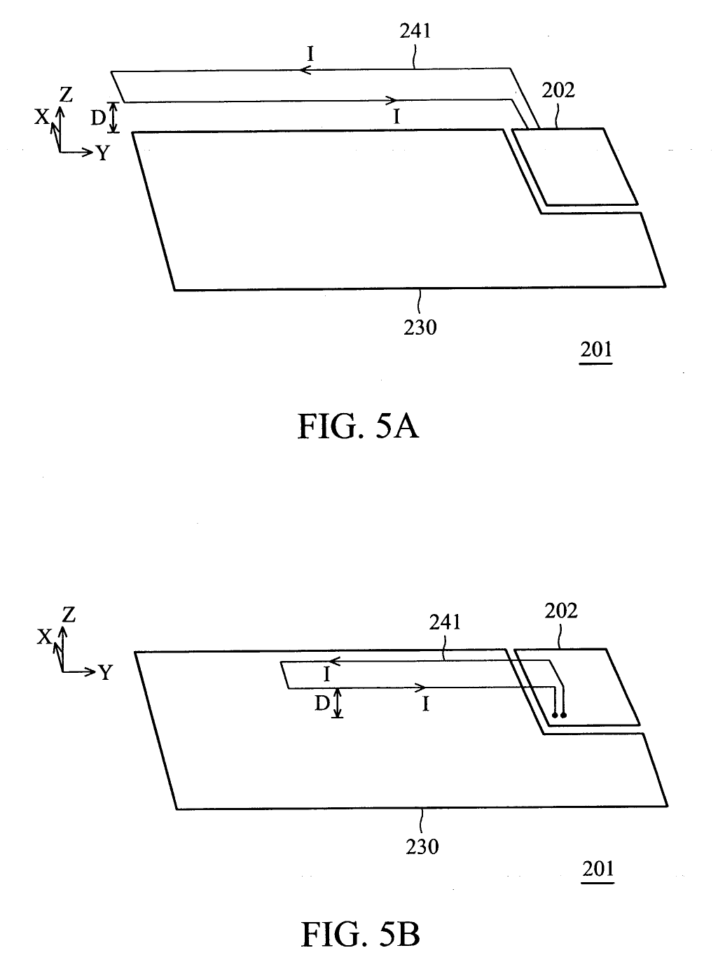

The wireless keyboard in the third embodiment is similar to the antenna system in the first embodiment. The difference is that the monopole antenna 240 is replaced by the loop antenna 241 shown in FIG. 5A. The first end of the loop antenna 241 is coupled to the wireless transmission circuit 210 of the RF module 202. The ground end of the wireless transmission circuit 210 is coupled to the ground 220. The loop antenna 241 is near an edge of the metallic plate 230 and is parallel to the edge of the metallic plate 230, but does not contact any portion of the metallic plate and thereby isolated there from. The distance between the antenna 240 and the metallic plate 230 is D, and D is less than 2 centimeter.

The improvement of radiation efficiency is the same as that in the first embodiment.

The Fourth Embodiment

The wireless keyboard in the fourth embodiment is similar to the antenna system in the second embodiment. The difference is that the monopole antenna 240 is replaced by a loop antenna 241 shown in FIG. 5B. The first end of the loop antenna 241 is coupled to the wireless transmission circuit 210 of the RF module 202. The ground end of the wireless transmission circuit 210 is coupled to the ground 220. The loop antenna 241 is above the metallic plate 230 and is parallel to the edge of the metallic plate 230, but does not contact any portion of the metallic plate and thereby isolated there from. The distance between the antenna 240 and the metallic plate 230 is D, and D is less than 2 centimeter.

The improvement of radiation efficiency is the same as that in the second embodiment.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. An antenna system for a wireless input device comprising:
an antenna for radiating signals from the wireless input device; and
a metallic conductor, separated from the antenna in a distance D and isolated from the antenna, for enhancing radiation efficiency; wherein D is less than 2 centimeters.

2. The antenna system as claimed in claim 1 wherein the metallic conductor is a metallic plate.

3. The antenna system as claimed in claim 1 wherein the antenna is a loop antenna.

4. The antenna system as claimed in claim 1 wherein the antenna is a monopole antenna.

5. The antenna system as claimed in claim 2 wherein the antenna is near an edge of the metallic plate.

6. The antenna system as claimed in claim 2 wherein the antenna is above the metallic plate.

7. An antenna system for a wireless keyboard comprising:
an antenna for radiating signals from the wireless device; and a metallic conductor, separated from the antenna by a distance D and isolated from the antenna, for enhancing radiation efficiency; wherein D is less than 2 centimeter.

8. The antenna system as claimed in claim 7 wherein the metallic conductor is a metallic plate.

9. The antenna system as claimed in claim 7 wherein the antenna is a loop antenna.

10. The antenna system as claimed in claim 7 wherein the antenna is a monopole antenna.

11. The antenna system as claimed in claim 8 wherein the antenna is near an edge of the metallic plate.

12. The antenna system as claimed in claim 8 wherein the antenna is over the metallic plate.
